(19) United States
(12) Patent Application Publication
(10) Pub. No.: US 2024/0196898 A1
(43) Pub. Date: Jun. 20, 2024

(54) INSANITARY INSECT PEST CONTROL METHOD USING CONDENSED HETEROCYCLIC COMPOUND

(71) Applicant: SUMITOMO CHEMICAL COMPANY, LIMITED, Chuo-ku (JP)

(72) Inventor: Ayako OKUDA, Takarazuka-shi (JP)

(73) Assignee: SUMITOMO CHEMICAL COMPANY, LIMITED, Chuo-ku (JP)

(21) Appl. No.: 18/553,870

(22) PCT Filed: Apr. 18, 2022
(86) PCT No.: PCT/JP2022/017997

§ 371 Date: Oct. 4, 2023

(30) Foreign Application Priority Data
Apr. 21, 2021 (JP) 2021-071590
Jul. 28, 2021 (JP) 2021-123406

(51) Int. Cl. A01N 47/02; A01P 7/04

(52) U.S. Cl. CPC A01N 47/02; A01P 7/04

(57) ABSTRACT

The present invention provides a sanitary insect pest control method, which comprises applying a sanitary insect pest control agent comprising at least one compound selected from the group consisting of a compound represented by formula (I):

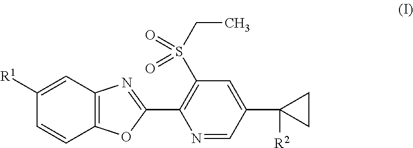

wherein
R¹ represents a C1-C3 haloalkoxy group, a C1-C3 haloalkylthio group, a C1-C3 haloalkylsulfinyl group or a C1-C3 haloalkylsulfonyl group, and R² represents a hydrogen atom or a cyano group, an N-oxide thereof and a salt thereof to a place through which a sanitary insect pest can pass, a place where the sanitary insect pest can inhabit, or both the places so that an amount of an active ingredient per 1 m² becomes 5 to 1,000 mg.

### TECHNICAL FIELD

This patent application claims the priority and benefit from the Paris Convention based on Japanese Patent Application No. 2021-071590 (filed on Apr. 21, 2020) and Japanese Patent Application No. 2021-123406 (filed on Jul. 28, 2021), the entire content of which is incorporated herein by reference.

The present invention relates to a method for controlling a sanitary insect pest using a certain fused heterocyclic compound.

### BACKGROUND ART

Patent Documents 1 to 4 disclose fused heterocyclic compounds having insecticidal activity.

### PRIOR ART DOCUMENT

### Patent Document

[Patent Document 1] WO 2017/146226
[Patent Document 2] WO 2020/175491
[Patent Document 3] JP 2014-5263 A
[Patent Document 4] JP 2016-506360 A

### DISCLOSURE OF THE INVENTION

### Problems to be Solved by the Invention

An object of the present invention is to provide a simple and effective method for controlling a sanitary insect pest using a fused heterocyclic compound.

### Means for Solving the Problems

The present invention includes the following aspects but is not limited thereto.
[1] A sanitary insect pest control method (hereinafter referred to as “invented control method”), which comprises applying a sanitary insect pest control agent (hereinafter referred to as “present sanitary insect pest control agent”) comprising at least one compound (hereinafter referred to as “present compound”) selected from the group consisting of a compound represented by formula (I) (hereinafter referred to as “compound (I)”):

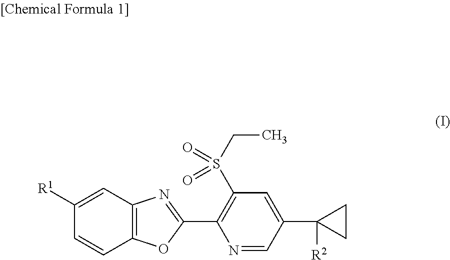

wherein
   R¹ represents a C1-C3 haloalkoxy group, a C1-C3 haloalkylthio group, a C1-C3 haloalkylsulfinyl group or a C1-C3 haloalkylsulfonyl group, and
   R² represents a hydrogen atom or a cyano group, an N-oxide thereof and a salt thereof to a place through which a sanitary insect pest can pass, a place where the sanitary insect pest can inhabit, or both the places so that an amount of an active ingredient per 1 m² becomes 5 to 1,000 mg.
[2] The sanitary insect pest control method according to [1], wherein the amount of the active ingredient per 1 m² is 5 to 300 mg.
[3] The sanitary insect pest control method according to [1] or [2], wherein R¹ is a trifluoromethylsulfinyl group or a trifluoromethylsulfonyl group, and R² is a hydrogen atom in formula (I).
[4] The sanitary insect pest control method according to any one of [1] to [3], wherein the place through which the sanitary insect pest can pass or the place where the sanitary insect pest can inhabit, or both the places is/are composed of a surface constituting an indoor or outdoor structure, or a surface around the structure.
[5] The sanitary insect pest control method according to [4], wherein a treatment with the sanitary insect pest control agent includes supporting the compound of formula (I) on any one of the surfaces.
[6] The sanitary insect pest control method according to any one of [1] to [5], wherein the sanitary insect pest control agent is a sanitary insect pest control agent which further contains at least one active ingredient.
[7] The sanitary insect pest control method according to [6], wherein the active ingredient is at least one selected from the group consisting of cypermethrin, alpha-cypermethrin, bifenthrin, cyfluthrin, beta-cyfluthrin, lambda-cyhalothrin, deltamethrin, esfenvalerate, etofenprox, prallethrin, permethrin, pyrethrins, chlorfenapyr, abamectin, acetamiprid, clothianidin, dinotefuran, resmethrin, imidacloprid, thiamethoxam, thiacloprid, indoxacarb, broflanilide, fenitrothion, cyphenothrin, pyriproxyfen, fipronil, phenothrin, sulfoxaflor, broflanilide, pirimiphos-methyl, bendiocarb, piperonyl butoxide and N-(2-ethylhexyl)-8,9,10-trinorborn-5-ene-2,3-dicarboxyimide.
[8] The sanitary insect pest control method according to any one of [1] to [7], wherein the sanitary insect pest is at least one sanitary insect pest selected from the group consisting of sanitary insect pests of the orders Blattodea, Hymenoptera, Diptera, Siphonaptera, Acari, Lepidoptera and Coleoptera.
[9] The sanitary insect pest control method according to any one of [1] to [8], which includes spraying the sanitary pest control agent after being diluted with water.
[10] The sanitary insect pest control method according to any one of [1] to [9], wherein the sanitary insect pest control agent is an oil, an emulsifiable concentrate, a wettable powder, a water dispersible granule, a flowable or a microcapsule.

### Effects of the Invention

According to the present invention, a sanitary insect pest can be easily controlled.

### MODE FOR CARRYING OUT THE INVENTION

A description will be made of the present compound which is used in the sanitary insect pest control method of the present invention (hereinafter referred to as “invented control method”).

The substituent R¹ of the compound of formula (I) will be first described.

Examples of the C1-C3 haloalkoxy group include a trifluoromethyl group, a difluoromethyl group, a 2,2,2-trifluoroethyl group, a 1,1,2,2-tetrafluoroethyl group, a pentafluoroethyl group, a heptafluoropropyl group and a 2,2,3,3,3-pentafluoropropyl group.

Examples of the C1-C3 haloalkylthio group include a trifluoromethylthio group, a difluoromethylthio group, a 2,2,2-trifluoroethylthio group, a 1,1,2,2-tetrafluoroethylthio group, a pentafluoroethylthio group, a heptafluoropropylthio group and a 2,2,3,3,3-pentafluoropropylthio group.

Examples of the C1-C3 haloalkylsulfinyl group include a trifluoromethylsulfinyl group, a difluoromethylsulfinyl group, a 2,2,2-trifluoroethylsulfinyl group, a 1,1,2,2-tetrafluoroethylsulfinyl group, a pentafluoroethylsulfinyl group, a heptafluoropropylsulfinyl group and a 2,2,3,3,3-pentafluoropropylsulfinyl group.

Examples of the C1-C3 haloalkylsulfonyl group include a trifluoromethylsulfonyl group, a difluoromethylsulfonyl group, a 2,2,2-trifluoroethylsulfonyl group, a 1,1,2,2-tetrafluoroethylsulfonyl group, a pentafluoroethylsulfonyl group, a heptafluoropropylsulfonyl group and a 2,2,3,3,3-pentafluoropropylsulfonyl group.

Examples of the N-oxide of the compound (I) include a compound represented by the formula (II) (hereinafter referred to as “compound (II)”):

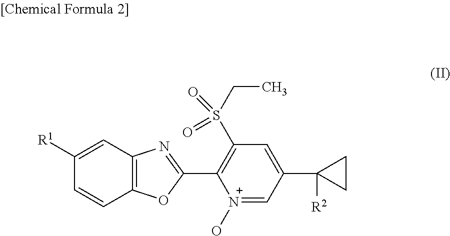

wherein symbols are the same as defined above.

The compound (I) and the compound (II) may have one or more stereoisomers. Examples of the stereoisomer include an enantiomers and a diastereomer. The present compound includes each stereoisomer and a stereoisomeric mixture in any ratio.

The compound (I) and the compound (II) may form an acid addition salt. Examples of an acid which forms the acid addition salt include inorganic acids such as hydrogen chloride, phosphoric acid and sulfuric acid; and organic acids such as acetic acid, trifluoroacetic acid, benzoic acid and p-toluenesulfonic acid. The acid addition salt is obtained by mixing the present compound with the acid.

Examples of the aspect of the compound (I) and the compound (II) include, but are not limited to, the following compounds.
[1] A compound in which R¹ is a C1-C3 haloalkylsulfinyl group or a C1-C3 haloalkylsulfonyl group, and R² is a hydrogen atom.
[2] A compound in which R¹ is a C1-C3 haloalkylsulfinyl group, and R² is a hydrogen atom.
[3] A compound in which R¹ is a C1-C3 haloalkylsulfonyl group, and R′ is a hydrogen atom.
[4] A compound in which R¹ is a trifluoromethylsulfinyl group or a trifluoromethylsulfonyl group, and R² is a hydrogen atom.
[5] A compound in which R¹ is a trifluoromethylsulfinyl group, and R² is a hydrogen atom.
[6] A compound in which R¹ is a trifluoromethylsulfonyl group, and R² is a hydrogen atom.

Next, a method for producing the compound (I) and the compound (II) will be described.

The compound (I) can be produced according to the methods mentioned, for example, in WO 2016/121997, WO 2017/146226 and WO 2020/117487.

### Production Method 1

The compound (II) can be produced by reacting the compound (I) with an oxidizing agent, as shown in the following scheme.

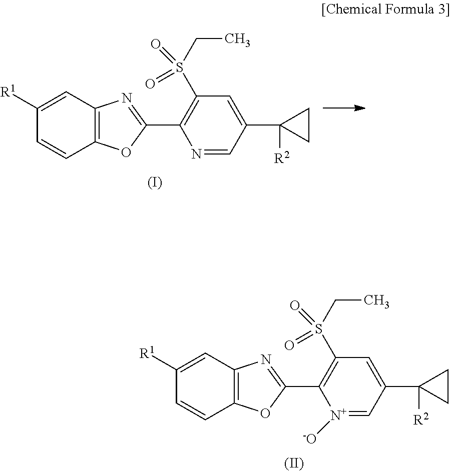

wherein symbols are the same as defined above.

The reaction is usually performed in the presence of a solvent. Examples of the solvent used in the reaction include halogenated hydrocarbons such as dichloromethane and chloroform (hereinafter referred to as halogenated hydrocarbons); nitriles such as acetonitrile nitrile (hereinafter referred to as nitriles); acetic acid; water and a mixture of two or more thereof.

Examples of the oxidizing agent used in the reaction include sodium periodate, m-chloroperoxybenzoic acid and hydrogen peroxide.

When hydrogen peroxide is used as the oxidizing agent, a base or a catalyst may be added as necessary.

Examples of the base used in the reaction include sodium carbonate. When the base is used in the reaction, the base is usually used in the ratio of 0.01 to 1 mol based on 1 mol of the compound (I).

Examples of the catalyst used in the reaction include sodium tungstate. When the catalyst is used in the reaction, the catalyst is usually used in the ratio of 0.01 to 0.5 mol based on 1 mol of the compound (I).

In the reaction, the oxidizing agent is usually used in the ratio of 1 to 2 mol based on 1 mol of the compound (I).

The reaction temperature is usually in the range of −20 to 120° C. The reaction time is usually in the range of 0.1 to 12 hours.

After completion of the reaction, water is added to the reaction mixture and, after extraction with an organic solvent, the organic layer is washed with an aqueous solution of a reducing agent (for example, sodium sulfite, sodium thiosulfate) and an aqueous solution of a base (for example, sodium hydrogen carbonate) as necessary. A compound (II) can be obtained by drying and concentrating this organic layer.

The following are examples of the present compound produced according to any of the production methods mentioned herein.

Compound in which R¹ and R² are combinations of any of substituents listed in [Table S1] and [Table S2] in compound (I) (hereinafter referred to as compound group SX1).

Compound in which R¹ and R² are combinations of any of substituents listed in [Table S1] and [Table S2] in compound (II) (hereinafter referred to as compound group SX2).

### Table 1

TABLE S1

| R1 | R2 |
|---|---|
| SCF₃ | H |
| SCHF₂ | H |
| SCH₂F | H |
| SCH₂CF₃ | H |
| SCH₂CHF₂ | H |
| SCH₂CH₂F | H |
| SCF₂CF₃ | H |
| SCF₂CHF₂ | H |
| SOCF₃ | H |
| SOCHF₂ | H |
| SOCH₂F | H |
| SOCH₂CF₃ | H |
| SOCH₂CHF₂ | H |
| SOCH₂CH₂F | H |
| SOCF₂CF₃ | H |
| SOCF₂CHF₂ | H |
| SO₂CF₃ | H |
| SO₂CHF₂ | H |
| SO₂CH₂F | M |
| SO₂CH₂CF₃ | H |
| SO₂CH₂CHF₂ | H |
| SO₂CH₂CH₂F | H |
| SO₂CF₂CF₃ | H |
| SO₂CF₂CHF₂ | H |
| OCF₃ | H |
| OCHF₂ | H |
| OCH₂CF₃ | H |
| OCH₂CHF₂ | H |
| OCF₂CF₃ | H |
| OCF₂CHF₂ | H |
| OCH₂CH₂CF₃ | H |
| OCH₂CH₂CHF₂ | H |
| OCF₂CF₂CF₃ | H |

TABLE S2

| R1 | R2 |
|---|---|
| SCF₃ | CN |
| SCHF₂ | CN |
| SCH₂F | CN |
| SCH₂CF₃ | CN |
| SCH₂CHF₂ | CN |
| SCH₂CH₂F | CN |
| SCF₂CF₃ | CN |
| SCF₂CHF₂ | CN |
| SOCF₃ | CN |
| SOCHF₂ | CN |
| SOCH₂F | CN |
| SOCH₂CF₃ | CN |
| SOCH₂CHF₂ | CN |
| SOCH₂CH₂F | CN |
| SOCF₂CF₃ | CN |
| SOCF₂CHF₂ | CN |
| SO₂CF₃ | CN |
| SO₂CHF₂ | CN |
| SO₂CH₂F | CN |
| SO₂CH₂CF₃ | CN |
| SO₂CH₂CHF₂ | CN |
| SO₂CH₂CH₂F | CN |
| SO₂CF₂CF₃ | CN |
| SO₂CF₂CHF₂ | CN |
| OCF₃ | CN |
| OCHF₂ | CN |
| OCH₂CF₃ | CN |
| OCH₂CHF₂ | CN |
| OCF₂CF₃ | CN |
| OCF₂CHF₂ | CN |
| OCH₂CH₂CF₃ | CN |
| OCH₂CH₂CHF₂ | CN |
| OCF₂CF₂CF₃ | CN |

When using the present compound in the present embodiment, the present compound is usually mixed with an appropriate solid or liquid carrier, and as necessary, a surfactant, a thickener, a protective colloid agent, an antifreezing agent, a defoamer, a fungicide, a preservative/bactericide, an antioxidant, a photostabilizer, a pH adjuster, a binder, a fixing agent/spreading agent, a lubricant, an anticaking agent, a perfume, a coating agent, an inclusion agent and the like are added to the mixture, to formulate into formulations with any dosage form such as a soluble concentrate, an oil, an emulsifiable concentrate, a wettable powder, a water soluble powder, a water dispersible granule, a water based suspension concentrate, an oil based suspension concentrate, an emulsion in water, a suspoemulsion, a microemulsion, a microcapsule, a dustable powder, a granule, a tablet or an emulsifiable gel to be used in practice. From the viewpoint of labor saving and improvement in safety, the formulations with any dosage form can also be used in practice after being enclosed in a water soluble package such as a water soluble capsule or a bag of a water soluble film.

Of these, particularly preferred are an emulsifiable concentrate, a wettable powder, a water soluble powder, a water dispersible granule, a water based suspension concentrate, an emulsion in water, a suspoemulsion in water, a microemulsion in water and a microcapsule in view of the handleability.

An inert carrier usable in the composition according to the present embodiment composition may be either solid or liquid.

Examples of a solid carrier include inorganic substances: minerals (natural silicate, marble, pumice, limestone, rare earth mineral, cryolite, activated clay, lime, activated carbon, talc, attapulgite, sodium montmorillonite, calcium montmorillonite, kaolinite, calcite, dolomite, diatomite, bentonite, zeolite, sepiolite, pyrophylite, vermiculite, crystalline silica, amorphous silica, etc.), silicon dioxide, calcium sulfate, magnesium sulfate, barium sulfate, magnesium oxide, aluminum oxide, ammonium sulfate, ammonium phosphate, ammonium nitrate, calcium phosphate, sulfur, calcium carbonate, sodium hydrogen carbonate, sodium carbonate, synthetic silicate, and grinds thereof; natural organic substances: grain fluor (rice bran, rice flour, corn flour, wheat flour, etc.), saccharides (cellulose, starch, lactose, glucose, fructose, sucrose, etc.), flour derived from plants (ground nut shell (ground nut shell of coconut, walnut, peanut, etc.), fluor derived from timbers (bark fluor, sawdust, etc.), other ground plant fluor (tobacco stems, soybean, cottonseed hull, etc.)), lignin, wax, shell, urea, polyethylene, polypropylene, polyvinyl alcohol, polycarbonate, polyester, polyamide, polyurethane, polyvinyl chloride, polyvinyl acetate, ethylene-vinyl acetate copolymer, ethylene-methyl methacrylate copolymer, polyvinylpyrrolidone-methacrylic acid copolymer, polyvinylpyrrolidone-vinyl acetate copolymer, cellulose derivatives, phenol resin, melamine resin, epoxy resin and the like. The solid carrier can also be used as an adsorption carrier.

Examples of a liquid carrier include water, aliphatic hydrocarbons (hexane, 1-hexene, cyclohexane, octane, isooctane, 1-heptene, d-limonene, pinene, hexadecane, etc.), aromatic hydrocarbons (alkylbenzene (toluene, xylene, isopropylbenzene, p-diethylbenzene, etc.), derivatives of alkylbenzene, alkylnaphthalene, derivatives of alkylnaphthalene, tetrahydronaphthalene, etc.), chlorinated (monochloroethylene, dichloroethylene, hydrocarbons trichloroethylene, tetrachloroethylene, dichloromethane, 1,1,1-trichloroethane, 1,1,2-trichloroethane, 1,2-dichloropropane, etc.), ketones (cyclohexanone, acetone, 2-heptanone, isophorone, mesityl oxide, methyl isoamyl ketone, methyl ethyl ketone, methyl isobutyl ketone, acetophenone, diacetone alcohol, methylcyclohexanone, etc.), esters (fatty acid ester (ethyl acetate, butyl acetate, amyl acetate, isoamyl acetate, isobornyl acetate, hexyl acetate, heptyl acetate, octyl acetate, isopropyl myristate, methyl octanoate, methyl oleate, methyl laurate, dibutyl adipate, tributyl citrate and dibutyl phthalate), lactic acid ester (ethyl lactate, propyl lactate, etc.), carbonic acid ester (ethylene carbonate, propylene carbonate, butylene carbonate, diethyl carbonate, dibutyl carbonate, etc.), esterified polyols (glycerol acetate, glycol acetate, glycerin monoacetate, glycerin diacetate, glycerin triacetate, diethylene glycol abietate, dipropylene glycol dibenzoate, dipropylene glycol monomethyl ester, etc.), lactone (γ-butyrolactone, etc.), ethers (1,4-dioxane, tetrahydrofuran, dipropylene glycol methyl ether, ethylene glycol methyl ether, propylene glycol methyl ether, etc.), amides (N-octyl-caprolactam, N-dodecyl-caprolactam, N, N-dimethylformamide, fatty acid dimethylamide (N, N-dimethylacetamide, N, N-dimethyldecanamide, N, N-dimethyloctanamide, etc.), alkylpyrrolidone (N-methylpyrrolidone, N-octyl-pyrrolidone, N-dodecyl-pyrrolidone, etc.), lactam (α-lactam, β-lactam, γ-lactam, δ-lactam, etc.), amines (octylamine, octylamine acetate, oleylamine, diethanolamine, laurylamine, etc.), alcohols (methanol, ethanol, butanol, propanol, isopropanol, butanol, amyl alcohol, hexanol, heptanol, octanol, 2-ethylhexanol, etc.), hexylene glycol, cyclohexanol, phenol, benzyl alcohol, methoxypropanol (1-methoxy-2-propanol), tetrahydrofurfuryl alcohol, furfuryl alcohol, polyethylene glycol, ethylene glycol, diethylene glycol, hexylene glycol, ethylene glycol methyl ether, diethylene glycol methyl ether, diethylene glycol butyl ether, triethylene glycol, propylene glycol methyl ether, dipropylene glycol, ethylene glycol monomethyl ether, ethylene glycol monoethyl ether, ethylene glycol butyl ether, dipropylene glycol methyl ether, dipropylene glycol ether, dipropylene glycol monomethyl ether, glycerin, etc., mineral oils (naphtha, petroleum ether, kerosene, diesel oil, paraffin, olefin, etc.), oils derived from animals and plants, oils derived from plants (palm oil, rapeseed oil, castor oil, coconut oil, soybean oil and derivatives thereof, etc.), oils derived from animals (sardine oil, saury oil, whale oil, and derivatives thereof, etc.), dimethyl sulfoxide, silicone oil, acetonitrile, propanenitrile, acid anhydride (acetic anhydride, etc.), triethyl phosphate, oleic acid, propionic acid, lactic acid, xylenesulfonic acid and the like.

These solid and liquid carriers may be used alone or in combination of two or more thereof.

Examples of the surfactant include an anionic surfactant, a cationic surfactant, an amphoteric surfactant and a nonionic surfactant.

The anionic surfactant includes, for example, carboxylic acids, sulfonic acids, sulfuric acid esters and phosphoric acid esters, and specific examples thereof include the following.

Carboxylic acids: fatty acid salt (octanoate, decanoate, laurate, myristate, palmitate, stearate, behenante, oleate, polyoxyethylene alkyl ether carboxylate (laureth-3-carboxylate, α-(carboxymethyl)-ω-(dodecyloxy) poly(oxyethylene) salt, etc.), N-acylsarcosine salt (N-lauroylsarcosine salt, etc.), N-acylglutamate (N-lauroylglutamate, etc.), polycarboxylate (polyacrylate, polyvinyl acetate, comb polymer of polyacid salt, and derivatives thereof, etc.);

Sulfonic acids: alkylsulfonic acid and salts thereof (dodecylsulfonate, etc.), alpha-olefin sulfonate (alkene (C14-18) hydroxysulfonate, alkapolyene(C12-20) hydroxysulfonate, alkene (C14-18) hydroxysulfonate, alkene (C12-20) hydroxysulfonate, tetradecene-1-sulfonate, α-olefin (C14-16) sulfonate, etc.), alkyl benzene sulfonate (decyl benzene sulfonate, dodecyl benzene sulfonate, tridecyl benzene sulfonate, diphenyl sulfonate, etc.), alkyl naphthalene sulfonate (naphthalene sulfonate, 6-methyl-2-naphthalene sulfonate, dibutyl naphthalene sulfonate, 2,2′-dinaphthylmethane-6,6′-disulfonate, diisopropyl naphthalene sulfonate, triisopropyl naphthalene sulfonate, 1-isopropyl-2-naphthalene sulfonate, etc.), sulfosuccinic acid, monoalkyl sulfosuccinate, dialkyl sulfosuccinate, (di(2-ethylhexyl) sulfosuccinate, etc.), N-methyl-N-acyl taurate (oleoyl methyl taurate, etc.), lignin sulfonate, alkylphenol sulfonate, naphthalene sulfonate-formaldehyde condensate, benzimidazole sulfonate and derivatives thereof;

Sulfuric acid esters: alkyl sulfate (hexyl sulfate, heptyl sulfate, octyl sulfate, lauryl sulfate, laurylsulfuric acid diethanol salt, hexadecyl sulfate, octadecyl sulfate, etc.), polyoxyethylene alkyl ether sulfuric acid and salts thereof (laureth-3-sulfate, polyoxyethylene monotridecyl ether sulfate, α-sulfo-ω-hydroxyalkyl(C6-10) ether poly (oxyethylene) salt, etc.), polyoxyethylene alkyl phenyl ether sulfate (poly(oxyethylene) 2-decylphenyl ether sulfate, poly(oxyethylene) 3-decylphenyl ether sulfate, α-sulfo-ω-[2,4-bis(1,1,3,3-tetramethylbutyl)phenoxy]poly(oxyethylene) salt, etc.), polyoxypropylene alkyl ether sulfate, lignosulfite waste liquor, and derivatives thereof; and

Phosphoric acid esters: alkyl phosphate (propyl phosphate, hexadecyl phosphate, lauryl phosphate, dioctyl phosphate, etc.), polyoxyethylene alkyl ether phosphate (polyoxyethylene decyl phosphate, α-phosphono-ω-butoxypoly(oxyethylene), etc.), polyoxyethylene alkyl phenyl ether phosphate (α-(dinonylphenyl)-ω-hydroxypoly(oxyethylene)phosphoric acid ester, α-(dodecylphenyl)-ω-hydroxypoly(oxyethylene)phosphoric acid ester, α-(nonylphenyl)-ω-hydroxypoly(oxyethylene)phosphoric acid ester, etc.), polyoxypropylene alkyl ether phosphate, and derivatives thereof.

The cationic surfactant includes, for example, amine salts and quaternary ammonium salts, and specific examples thereof include the following.

Amine salts: alkylamine salt (monomethylamine salt, dimethylamine salt, trimethylamine salt, etc.), fatty acid amido amine salt (stearamidopropyl dimethylamine, behenamidopropyl dimethylamine, etc.), polyamine salt (polyvinylamine, polyethyleneimine, etc.), and derivatives thereof; and

Quaternary ammonium salts: lauryl trimethyl ammonium salt, cetyl trimethyl ammonium salt, dodecyl trimethyl ammonium salt, stearyl trimethyl ammonium salt, benzalkonium chloride, benzethonium chloride and benzylbis(2-chloroethyl)ethylammonium bromide salt.

Examples of the amphoteric surfactant include betaine, alkylbetaine, alkyldimethylbetaine, imidazoline, taurine, alkyltaurine, dodecyldimethylammonioacetate, 4-carboxy-N, N, N-trimethyl-1-butanaminium, 1-carboxy-N, N, N-2-2-tetramethyl-1-propanaminium, N-alkyl(or alkenyl)(C12-18)glycine and salts thereof, N-dodecyl glycine and salts thereof, and derivatives thereof.

The nonionic surfactant includes, for example, alcohols, amides, amines, esters, ethers, ether esters and carboxylic acids, and specific examples thereof include the following.

Alcohols: aromatic alcohol (alkylphenol (allylphenol, octylphenol, nonylphenol, octylcresol, etc.), acylphenol, etc.), aliphatic alcohol (isotridecyl alcohol, oleyl alcohol, cetyl alcohol, etc.), polyhydric alcohol (polysaccharides, starch, starch derivative, sucrose, alkyl polyglucoside, sorbitan, ethoxylated sorbitan, cellulose derivatives, gum arabic, etc.), synthetic polymer (polyvinyl alcohol, polyethylene glycol, etc.);

Amides: alkanolamide (fatty acid alkanolamide (lauric acid diethanolamide, etc.), fatty acid glucamide (alkoxylated propylene oxide fatty acid glucamide, etc.), alkoxylated amide (polyoxyethyleneoleic acid amide, polyoxyethylenestearic acid amide, etc.), synthetic polymer (polyvinylpyrrolidone, etc.);

Amines: alkoxylated amine (polyoxyethyleneoleylamine, α,α′-[(9-octadecenylimino)di-2,1-ethanediyl]bis(ω-hydroxy) polyoxyethylene, etc.);

Esters: fatty acid ester (fatty acid ester of polyol, monoglyceride, phospholipid, etc.), ester derived from saccharide (sucrose fatty acid ester (sucrose stearic acid diester, etc.), sorbitan fatty acid ester (sorbitan oleic acid monoester, etc.), glucose ester, cellulose ester, etc.), synthetic polymer (vinyl acetate copolymer, polymethacrylic acid, copolymer of methacrylic acid and methacrylic acid ester, etc.);

Ethers: alcohol ethoxylate (aliphatic alcohol ethoxylate (tridecyl alcohol ethoxylate, isooctyl alcohol ethoxylate, lauryl alcohol ethoxylate, hexadecyl alcohol ethoxylate, stearyl alcohol ethoxylate), etc.), alkylphenol ethoxylate (nonylphenol ethoxylate, tristyryl phenol ethoxylate, tributylphenol ethoxylate, octylphenol ethoxylate, etc.), arylalkylphenol ethoxylate, arylphenol ethoxylate (monobenzylbiphenol alcohol ethoxylate, etc.), alcohol propoxylate (aliphatic alcohol propoxylate, alkylphenol propoxylate, arylalkylphenol propoxylate, etc.), block polymer (block polymer of polyethylene oxide and polypropylene oxide, polyethylene oxide block polymer, polypropylene oxide block polymer, block polymer of alkanol, polyethylene oxide and polypropylene oxide, etc.);

Ether esters: polyoxyethylene fatty acid ester (polyoxyethylene castor oil ester, polyoxyethylene stearic acid ester, polyoxyethylene beef tallow fatty acid ester, etc.), polyoxyethylene sorbitan fatty acid ester (polyoxyethylene sorbitan monooleic acid ester, polyoxyethylene sorbitan trioleic acid ester, polyoxyethylene sorbitan monolauric acid ester, polyoxyethylene sorbitan stearic acid ester, etc.), polyoxyethylene fatty acid amine ester, polyoxyethylene rosin ester, polyoxypropylene fatty acid ester (polyoxypropylene castor oil ester, etc.), polyoxypropylene fatty acid amine ester; and

Carboxylic acids: undecafluorohexanoic acid.

The content of the surfactant is not particularly limited, but is preferably 0.05 to 20 parts by weight based on 100 parts by weight of the formulation. These surfactants may be used alone or in combination of two or more thereof.

Examples of the thickener include polysaccharides (xanthan gum, cellulose ester, cellulose ether, carboxymethyl cellulose and salts thereof, dextrin, starch, guar gum, gum arabic, hydroxypropyl guar gum, tylose, carrageenan, etc.), clays (organic clay, organic modified clay, inorganic clay, inorganic modified clay, etc.), mineral (bentonite, attapulgite, silica, silicate, etc.), and synthetic polymer (polycarboxylate, polyacrylic acid derivatives, polyvinylpyrrolidone, polyvinyl alcohol, etc.) and the like. These thickeners may be used alone or in combination of two or more thereof.

Examples of the protective colloid agent include water soluble celluloses such as methyl cellulose, hydroxyethyl cellulose, hydroxypropyl cellulose, hydroxypropylmethyl cellulose and carboxymethyl cellulose; polyalkylene glycols such as polyethylene glycol and polypropylene glycol; polyvinyl alcohol, polyvinylpyrrolidone, guar gum, gum arabic, gelatin, polyacrylate, and alginate and the like. These protective colloid agents may be used alone or in combination of two or more thereof.

Examples of the antifreezing agent include alcohols (ethylene glycol, propylene glycol, dipropylene glycol, triethylene glycol, ethylene glycol methyl ether, propylene glycol methyl ether, dipropylene glycol methyl ether, ethylene glycol butyl ether, glycerin, polyethylene glycol, etc.), esters (dipropylene glycol dibenzoate, glycerol acetate, glycerol diacetate, glycerol triacetate, gamma-butyrolactone, etc.), ethers (1,4-dioxane, etc.), and urea. These antifreezing agents may be used alone or in combination of two or more thereof.

Examples the defoamer include silicones (polysiloxane, diblock ethoxylsiloxane, triblock ethoxylsiloxane, etc.), alkylsulfosuccinate, higher alcohol, higher alcohol derivatives, salts of fatty acid, and fatty acid derivatives. These defoamers may be used alone or in combination of two or more thereof.

Examples of the fungicide include benzothiazole derivatives, sorbic acid, potassium sorbate and butyl p-oxybenzoate. These fungicides may be used alone or in combination of two or more thereof.

Examples of the preservative/bactericide include phenols (ortho-phenylphenol, thymol, 3,5-dimethyl-4-chlorophenol, 2-isopropyl-5-methylphenol, 3-methyl-4-isopropylphenol), isothiazolinone derivatives (alkylisothiazolinone (5-chloro-2-methylisothiazolinone, 2-methylisothiazolinone, N-octylisothiazolinone), benzisothiazolinone N-(1,2-benzisothiazolinone, butylbenzoisothiazolinone), bronopol derivatives (bronopol)benzyl alcohol hemiformal, parabens (methylparaben, ethylparaben, propylparaben, isopropylparaben, butylparaben, isobutylparaben, heptylparaben, benzylparaben), imidazoles (thiabendazole, 2-(4-thiazoyl)benzimidazole), methyl 2-benzimidazoylcarbamate, benzalkonium chloride, didecyldimethylammonium chloride, glyceryl caprylate, glyceryl caprate, glycerin fatty acid ester, sodium dehydroacetate, hinokitiol, silver zeolite, silver salt, methylenebisthiocyanate, 2-bromo-2-nitropropane-1,3-diol, glutaraldehyde, iodopropynyl butylcarbamate, 1,2-dibromo-2,4-dicyanobutane, chlorhexidine gluconate, polyhexamethylene biguanide, parachlorometaxylenol, parachlorometacresol, polylysine, tetrachloroisophthalonitrile, diiodomethylparatolylsulfone, parachlorophenyl-3-iodopropargylformal, 2,3,5,6-tetrachloro-4-(methylsulfonyl)pyridine, lanthanum chloride, rare earth salt (scandium salt, yttrium salt, lanthanum salt, cerium salt, praseodymium salt, neodymium salt, samarium salt, europium salt, gadolinium salt, terbium salt, dysprosium salt, holmium salt, erbium salt, thulium salt, ytterbium salt, lutetium salt and the like, and examples of the counter ion include chloride, sulfate, nitrate, bromide, iodide, carbonate, phosphate, organic acid salt, hydroxide, etc.). Examples of the organic acid salt includes monovalent or divalent carboxylic acid, and a salt of hydroxy acid, and specific examples of the hydroxy acid include lactic acid, gluconic acid, tartaric acid, citric acid, malic acid, salicylic acid and the like; examples of the monovalent or divalent carboxylic acid include acetic acid, propionic acid, malonic acid, succinic acid, glutaric acid, adipic acid, azelaic acid, sorbic acid, benzoic acid and the like, and phosphoric acid and salts thereof. These preservatives/bactericides may be used alone or in combination of two or more thereof.

Examples of the antioxidant include phenols (2,6-di-t-butyl-p-cresol, 2,2′-methylenebis(4-methyl-6-t-butylphenol), etc.), amines (p, p′-dioctyldiphenylamine, N, N′-diphenyl-p-phenylenediamine, etc.), dibutylhydroxytoluene, butylhydroxyanisole, sodium erythorbate, sodium sulfite, potassium sulfite, potassium pyrosulfite, catechin, propyl gallate, sulfurs (dodecyl thiodipropionate, etc.), phosphoric acids (trisnonylphenylphosphite, etc.), vitamins (alpha-tocopherol, L-ascorbic acid, sodium ascorbate, ascorbyl palmitate, etc.) and the like. These antioxidants may be used alone or in combination of two or more thereof.

Examples of the photostabilizer include titanium oxide, zinc oxide, activated carbon, carbon black, ethylhexyl methoxycinnamate, tert-butyl methoxydibenzoylmethane, hindered amines, ferulic acid, phenyl hydroxybenzoate, ethyl paraaminobenzoate, octyl salicylate, t-butylphenyl salicylate, 4-tert-octylphenyl salicylate, 2-cyano-3,3-diphenylprop-2-enoic acid-2-ethylhexyl ester (octocrylene), drometriazole trisiloxane, 2,4,6-tris[4-(2-ethylhexyloxycarbonyl) anilino]-1,3,5-triazine (octyltriazone, TEAT), 2,2′-methylenebis[6-(2H-benzotriazol-2-yl)-4-(1,1,3,3-tetramethylbutyl) phenol] (MBP), 2-ethylhexyl paradimethylaminobenzoate (EDB), homomenthyl salicylate (HS), phenylbenzimidazolesulfonic acid (PBS), hydroxymethoxybenzophenonesulfonic acid (oxybenzone 4, OXB4), sodium hydroxymethoxybenzophenone sulfonate (oxybenzone 5, OXB5), sodium dihydroxydimethoxybenzophenone disulfonate (oxybenzone 9, OXB9), tetrahydroxybenzophenone, dihydroxybenzophenone, dihydroxydimethoxybenzophenone, 2-hydroxy-4-methoxybenzophenone, 2-ethylhexyl dimethoxybenzylidene dioxoimidazoline propionate, 2,4-dihydroxybenzophenone, bis(2-methoxy-4-hydroxy-5-benzoylphenyl) methane and the like. These photostabilizers may be used alone or in combination of two or more thereof.

Examples of the pH adjuster include sulfuric acid, nitric acid, hydrochloric acid, acetic acid, carbonic acid, oxalic acid, lactic acid, succinic acid, gluconic acid, citric acid, phosphoric acid, sorbic acid, and salts thereof, sodium hydrogen carbonate, sodium hydroxide, potassium hydroxide, calcium hydroxide, aluminum hydroxide, copper hydroxide, magnesium hydroxide and the like. These pH adjusters may be used alone or in combination of two or more thereof.

Examples of the binder include polysaccharides (xanthan gum, cellulose ester, cellulose ether, carboxymethyl cellulose, hydroxypropyl guar gum, guar gum, natural gum arabic, synthetic gum arabic, dextrin, starch, carrageenan, etc.), clays (organic clay, organic modified clay, inorganic clay, inorganic modified clay), minerals (bentonite), synthetic polymers (polycarboxylic acid or salts thereof, polyvinylpyrrolidone, vinyl polyacetate, polyvinyl alcohol, polyacrylic acid or salts thereof), waxes (vegetable fats and oils, animal fats and oils, and derivatives thereof, paraffin, olefin, etc.) and the like. These binders may be used alone or in combination of two or more thereof.

Examples of the fixing agent/spreading agent include the above-mentioned surfactants and liquid carriers (esters (alkyl fatty acid ester, sorbitan fatty acid ester, ethoxylated fatty acid ester, ethoxysorbitan fatty acid, etc.), alcohols (ethoxylated aliphatic alcohol, ethoxylated sorbitan fatty alcohol, etc.), waxes (vegetable fats and oils, animal fats and oils, and derivatives thereof, paraffin, olefin, etc.), vegetable oils (alkylated vegetable oil, etc.), mineral oils (mineral oil, etc.), silicone emulsion, synthetic polymers (styrene-butadiene copolymer, methyl methacrylate-butadiene copolymer, polyacrylic acid or salts thereof, vinyl polyacetate, polyvinyl alcohol, polyvinylpyrrolidone, polyethylene glycol, polypropylene glycol, etc.), natural polymers (xanthan gum, cellulose ester, cellulose ether, carboxymethyl cellulose or salts thereof, dextrin, starch, guar gum, gum arabic, hydroxypropyl guar gum, tylose, etc.) and the like. These fixing agents/spreading agents may be used alone or in combination of two or more thereof.

Examples of the lubricant include alcohols mentioned in the above-mentioned liquid carriers and surfactants, fatty acid esters, sucrose fatty acid esters, glycerin fatty acid esters, hydrocarbons, paraffin, ethylene wax, aliphatic amides, erucic acid amide, stearic acid amide, oleic acid amide, methylenebis stearic acid amide, ethylenebis stearic acid amide, metal soaps, lead stearate, zinc stearate, calcium stearate, magnesium stearate, mineral oil, vegetable oil, kerosene, diesel oil and the like. These lubricants may be used alone or in combination of two or more thereof.

Examples of the anticaking agent include the above-mentioned solid carriers and liquid carriers, calcium phosphate, phosphoric acid sodium, sodium carbonate, sodium silicate, calcium silicate, magnesium silicate, potassium aluminum silicate, dioxide, silicon talc, sodium aluminosilicate, calcium aluminosilicate, bentonite, stearic acid, dimethylpolysiloxane, powdered cellulose and the like. These anticaking agent may be used alone or in combination of two or more thereof.

Examples of the perfume include hydrocarbons, α-limonene, β-caryophyllene, alcohols, cis-3-hexenol, linalool, farnesol, β-phenylethyl alcohol, aldehydes, 2,6-nonadienal, citral, α-hexyl cinnamic aldehyde, ketones, β-ionone, L-carvone, cyclopentadecanone, esters, linalyl acetate, benzyl benzoate, lactones, γ-undecalactone, phenols, eugenol, oxides, rose oxide, acetals, phenylacetoaldehyde dimethyl acetal, α-pinene, β-pinene and the like. These perfumes may be used alone or in combination of two or more thereof.

Examples of the coating agent include natural rubber, synthetic rubber, resin (styrene-butadiene copolymer, polyacrylonitrile, polyester, polyamide, polyurethane, polyurea, polyether, rosin, melamine, etc.), wax (vegetable fats and oils, animal fats and oils, and derivatives thereof, paraffin, olefin, etc.), polysaccharides (xanthan gum, cellulose ester, cellulose ether, carboxymethyl cellulose or salts thereof, dextrin, starch, guar gum, gum arabic, hydroxypropyl guar gum, tylose, starch xanthate, carrageenan, etc.), protein (gelatin, etc.) and the like. These coating agents may be used alone or in combination of two or more thereof.

Examples of the inclusion agent include cyclodextrins, α-cyclodextrin, β-cyclodextrin, γ-cyclodextrin and the like. These inclusion agents may be used alone or in combination of two or more thereof.

The control agent according to the present embodiment may further contain, in addition to the present compound, at least one of one or more other insecticidal active ingredients and synergists which are commonly known. Examples of combinations of the present compound and other insecticidal active compounds, repellents and synergist are listed below. For example, alanycarb+SX means the combination of alanycarb and SX.

The abbreviation of “SX” means any one of the present compounds selected from the compound groups SX1 to SX2. All of other insecticidal active compound, repellents and synergists listed below are known ingredients, and can be obtained from commercially available formulations, or can be produced by known methods.

Combinations of other insecticidal active compounds and the present compound:
abamectin+SX, acephate+SX, acequinocyl+SX, acetamiprid+SX, acetoprole+SX, acrinathrin+SX, acynonapyr+SX, afidopyropen+SX, afoxolaner+SX, alanycarb+SX, aldicarb+SX, allethrin+SX, alpha-cypermethrin+SX, alpha-endosulfan+SX, aluminium phosphide+SX, amitraz+SX, azadirachtin+SX, azamethiphos+SX, azinphos-ethyl+SX, azinphos-methyl+SX, azocyclotin+SX, bark of Celastrus angulatus+SX, bendiocarb+SX, benfluthrin+SX, benfuracarb+SX, bensultap+SX, benzoximate+SX, benzpyrimoxan+SX, beta-cyfluthrin+SX, beta-cypermethrin+SX, bifenazate+SX, bifenthrin+SX, bioallethrin+SX, bioresmethrin+SX, bistrifluron+SX, borax+SX, boric acid+SX, broflanilide+SX, bromopropylate+SX, buprofezin+SX, butocarboxim+SX, butoxycarboxim+SX, cadusafos+SX, calcium phosphide+SX, carbaryl+SX, carbofuran+SX, carbosulfan+SX, cartap hydrochloride+SX, cartap+SX, cevadine+SX, chinomethionat+SX, chlorantraniliprole+SX, chlordane+SX, chlorethoxyfos+SX, chlorfenapyr+SX, chlorfenvinphos+SX, chlorfluazuron+SX, chlormephos+SX, chloropicrin+SX, chlorpyrifos+SX, chlorpyrifos-methyl+SX, chromafenozide+SX, clofentezine+SX, clothianidin+SX, concanamycin A+SX, coumaphos+SX, cryolite+SX, cyanophos+SX, cyantraniliprole+SX, cyclaniliprole+SX, cyclobutrifluram+SX, cycloprothrin+SX, cycloxaprid+SX, cyenopyrafen+SX, cyetpyrafen+SX, cyflumetofen+SX, cyfluthrin+SX, cyhalodiamide+SX, cyhalothrin+SX, cyhexatin+SX, cypermethrin+SX, cyphenothrin+SX, cyproflanilide+SX, cyromazine+SX, dazomet+SX, deltamethrin+SX, demeton-S-methyl+SX, diafenthiuron+SX, diazinon+SX, dichlorvos+SX, dicloromezotiaz+SX, dicofol+SX, dicrotophos+SX, diflovidazin+SX, diflubenzuron+SX, dimefluthrin+SX, dimethoate+SX, dimethylvinphos+SX, dimpropyridaz+SX, dinotefuran+SX, disodium octaborate+SX, disulfoton+SX, DNOC (2-methyl-4,6-dinitrophenol)+SX, doramectin+SX, dried leaves of Dryopteris filix-mas+SX, emamectin-benzoate+SX, empenthrin+SX, endosulfan+SX, EPN (O-ethyl 0-(4-nitrophenyl) phenylphosphonothioate)+SX, epsilon-metofluthrin+SX, epsilon-momfluorothrin+SX, esfenvalerate+SX, ethiofencarb+SX, ethion+SX, ethiprole+SX, ethoprophos+SX, etofenprox+SX, etoxazole+SX, extract of Artemisia absinthium+SX, extract of Azadirachta indica+SX, neem oil+SX, Extract of Cassia nigricans+SX, extract of clitoria ternatea+SX, extract of Symphytum officinale+SX, extracts or simulated blend of Chenopodium ambrosioides+SX, extract of Tanacetum vulgare+SX, extract of Urtica dioica+SX, extract of Viscum album+SX, extract of Tanacetum cinerariifolium+SX, famphur+SX, fenamiphos+SX, fenazaquin+SX, fenbutatin oxide+SX, fenitrothion+SX, fenmezoditiaz+SX, fenobucarb+SX, fenoxycarb+SX, fenpropathrin+SX, fenpyroximate+SX, fenthion+SX, fenvalerate+SX, fipronil+SX, flometoquin+SX, flonicamid+SX, fluacrypyrim+SX, fluazaindolizine+SX, fluazuron+SX, flubendiamide+SX, fluchlordiniliprole+SX, flucycloxuron+SX, flucythrinate+SX, fluensulfone+SX, flufenoprox+SX, flufenoxuron+SX, flufiprole+SX, flumethrin+SX, flupentiofenox+SX, flupyradifurone+SX, flupyrimin+SX, fluralaner+SX, fluvalinate+SX, fluxametamide+SX, formetanate+SX, fosthiazate+SX, furamethrin+SX, furathiocarb+SX, gamma-cyhalothrin+SX, GS-omega/kappa HXTX-Hvla peptide+SX, halfenprox+SX, halofenozide+SX, heptafluthrin+SX, heptenophos+SX, hexaflumuron+SX, hexythiazox+SX, potassium salt of hop beta acid+SX, hydramethylnon+SX, hydroprene+SX, imicyafos+SX, imidacloprid+SX, imidaclothiz+SX, imiprothrin+SX, indazapyroxamet+SX, indoxacarb+SX, isocycloseram+SX, isofenphos+SX, isoprocarb+SX, isopropyl-O-(methoxyaminothiophosphoryl) salicylate+SX, isoxathion+SX, ivermectin+SX, kadethrin+SX, kappa-tefluthrin+SX, kappa-bifenthrin+SX, kinoprene+SX, lambda-cyhalothrin+SX, lenoremycin+SX, lepimectin+SX, lime sulfur+SX, lotilaner+SX, lufenuron+SX, machine oil+SX, malathion+SX, mecarbam+SX, meperfluthrin+SX, metaflumizone+SX, metam+SX, methamidophos+SX, methidathion+SX, methiocarb+SX, methomyl+SX, methoprene+SX, methoxychlor+SX, methoxyfenozide+SX, methyl bromide+SX, metofluthrin+SX, metolcarb+SX, metoxadiazone+SX, mevinphos+SX, milbemectin+SX, milbemycin oxime+SX, momfluorothrin+SX, monocrotophos+SX, moxidectin+SX, naled+SX, nicofluprole+SX, nicotine+SX, nicotine-sulfate+SX, nitenpyram+SX, novaluron+SX, noviflumuron+SX, oil of the seeds of Chenopodium anthelminticum+SX, omethoate+SX, oxamyl+SX, oxazosulfyl+SX, oxydemeton-methyl+SX, parathion+SX, parathion-methyl+SX, permethrin+SX, phenothrin+SX, phenthoate+SX, phorate+SX, phosalone+SX, phosmet+SX, phosphamidon+SX, phosphine+SX, phoxim+SX, pirimicarb+SX, pirimiphos-methyl+SX, prallethrin+SX, profenofos+SX, profluthrin+SX, propargite+SX, propetamphos+SX, propoxur+SX, propylene glycol alginate+SX, prothiofos+SX, pyflubumide+SX, pymetrozine+SX, pyraclofos+SX, pyrethrins+SX, pyridaben+SX, pyridalyl+SX, pyridaphenthion+SX, pyrifluquinazone+SX, pyrimidifen+SX, pyriminostrobin+SX, pyriprole+SX, pyriproxyfen+SX, quinalphos+SX, resmethrin+SX, rotenone+SX, ryanodine+SX, sarolaner+SX, Seed extract of Anethum Graveolens+SX, seed extract of Schoenocaulon spp.+SX, selamectin+SX, sigma-cypermethrin+SX, silafluofen+SX, sodium borate+SX, sodium metaborate+SX, spidoxamat+SX, spinetoram+SX, spinosad+SX, spirodiclofen+SX, spiromesifen+SX, spiropidion+SX, spirotetramat+SX, sulfluramid+SX, sulfotep+SX, sulfoxaflor+SX, sulfur+SX, sulfuryl fluoride+SX, tartar emetic+SX, tau-fluvalinate+SX, tebufenozide+SX, tebufenpyrad+SX, tebupirimfos+SX, teflubenzuron+SX, tefluthrin+SX, temephos+SX, terbufos+SX, terpene constituents of the extract of chenopodium terpene constituents of the extract of Chenopodium ambrosioides near ambrosioides+SX, tetrachlorantraniliprole+SX, tetrachlorvinphos+SX, tetradifon+SX, tetramethrin+SX, tetramethylfluthrin+SX, tetraniliprole+SX, theta-cypermethrin+SX, thiacloprid+SX, thiamethoxam+SX, thiocyclam+SX, thiodicarb+SX, thiofanox+SX, thiometon+SX, thiosultap-disodium+SX, thiosultap-monosodium+SX, tioxazafen+SX, tolfenpyrad+SX, tralomethrin+SX, transfluthrin+SX, triazamate+SX, triazophos+SX, trichlorfon+SX, trifluenfuronate+SX, triflumezopyrim+SX, triflumuron+SX, trimethacarb+SX, tyclopyrazoflor+SX, vamidothion+SX, veratridine+SX, wood extract of Quassia amara+SX, XMC (3,5-dimethylphenyl N-methylcarbamate)+SX, xylylcarb+SX, zeta-cypermethrin+SX, zinc phosphide+SX, 4-[5-(3,5-dichlorophenyl)-5-(trifluoromethyl)-4,5-dihydro-1,2-oxazol-3-yl]-2-methyl-N-(1-oxothietan-3-yl)benzamide (1241050-20-3)+SX, 3-methoxy-N-(5-{5-(trifluoromethyl)-5-[3-(trifluoromethyl)phenyl]-4,5-dihydro-1,2-oxazol-3-yl}indan-1-yl)propanamide (1118626-57-5)+SX, 2-({2-fluoro-4-methyl-5-[(2,2,2-trifluoroethyl)sulfinyl]phenyl}imino)-3-(2,2,2-trifluoroethyl)-1,3-thiazolidin-4-one (1445683-71-5)+SX, (2Z)-2-({2-fluoro-4-methyl-5-[(R)-(2,2,2-trifluoroethyl)sulfinyl]phenyl}imino)-3-(2,2,2-trifluoroethyl)-1,3-thiazolidin-4-one (2377084-09-6)+SX, N-{4-chloro-3-[(1-cyanocyclopropyl)carbamoyl]phenyl}-1-methyl-4-(methanesulfonyl)-3-(1,1,2,2,2-pentafluoroethyl)-1H-pyrazole-3-carboxamide (1400768-21-9)+SX, 3-(4′-fluoro-2,4-dimethyl[1,1′-biphenyl]-3-yl)-4-hydroxy-8-oxa-1-azaspiro[4.5]dec-3-en-2-one (1031385-91-7)+SX, N-[3-chloro-1-(pyridin-3-yl)-1H-pyrazol-4-yl]-2-(methanesulfonyl)propanamide (2396747-83-2)+SX, 1,4-dimethyl-2-[2-(3-pyridin-3-yl)-2H-indazol-5-yl]-1,2,4-triazolidine-3,5-dione (2171099-09-3)+SX, 2-isopropyl-5-[(3,4,4-trifluoro-3-buten-1-yl)sulfonyl]-1,3,4-thiadiazole (2058052-95-0)+SX, N-({2-fluoro-4-[(2S,3S)-2-hydroxy-3-(3,4,5-trichlorophenyl)-3-(trifluoromethyl)pyrrolidin-1-yl]phenyl}methyl)cyclopropanecarboxamide+SX.

Combinations of the synergist and the present compound:
1-dodecyl-1H-imidazole+SX, N-(2-ethylhexyl)-8,9,10-trinorborn-5-ene-2,3-dicarboximide+SX, bucarpolate+SX, N,N-dibutyl-4-chlorobenzenesulfonamide+SX, dietholate+SX, diethylmaleate+SX, piperonyl butoxide+SX, piperonyl cyclonene+SX, piprotal+SX, propyl isome+SX, safroxan+SX, sesamex+SX, sesamolin+SX, sulfoxide+SX, Verbutin+SX, DMC (1,1-bis(4-chlorophenyl)ethanol)+SX, FDMC (1,1-bis(4-chlorophenyl)-2,2,2-trifluoroethanol)+SX, ETN (1,2-epoxy-1,2,3,4-tetrahydronaphthalene)+SX, ETP (1,1,1-trichloro-2,3-expoxypropane)+SX, PSCP (phenylsaligenin cyclic phosphate)+SX, TBPT (S,S,S-tributyl phosphorotrithioate)+SX, and TPP (triphenyl phosphate)+SX.

It is preferable to contain one or more compounds selected from the group consisting of the following compounds of the above other insecticidal active compounds and synergist which may be further contained:
cypermethrin, alpha-cypermethrin, bifenthrin, cyfluthrin, beta-cyfluthrin, lambda-cyhalothrin, deltamethrin, esfenvalerate, etofenprox, prallethrin, permethrin, pyrethrins, chlorfenapyr, abamectin, acetamiprid, clothianidin, dinotefuran, resmethrin, imidacloprid, thiamethoxam, thiacloprid, indoxacarb, broflanilide, fenitrothion, cyphenothrin, pyriproxyfen, fipronil, phenothrin, sulfoxaflor, broflanilide, pirimiphos-methyl, bendiocarb, piperonyl butoxide and N-(2-ethylhexyl)-8,9,10-trinorborn-5-ene-2,3-dicarboximide.

Regarding the weight ratio of the present compound to the total of the other insecticidal active compounds and the synergist, the amount of the other insecticidal ingredients is usually 0.01 to 100 parts by weight, and preferably 0.02 to 50 parts by weight, based on 1 part by weight of the present compound.

The content of the present compound in the control agent according to the present embodiment is not particularly limited, but is usually 0.1 to 99.9% by weight, preferably 1 to 90% by weight, and more preferably 3 to 80% by weight.

In the sanitary insect pest control method according to the present embodiment, the control agent according to the present embodiment may be used as it is, or may be used after being appropriately diluted or suspended with water. Usually, the control agent is used in the active ingredient concentration of preferably 0.0001 to 5,000 ppm, and more preferably 0.01 to 1,000 ppm.

The control agent according to the present embodiment may be used as a mixture with other types of nematicide, bactericides, synergists and the like during a treatment, as necessary.

As used herein, examples of the place through which a sanitary insect pest can pass and the place where a sanitary insect pest can inhabit include human habitations, commercial facilities, hospitals, stations, airports, factories, offices, schools, lodging facilities, waste treatment facilities, barns, warehouses, tents, vehicles, airplanes, ships, various products, grounds, forests, pastures, ditches and the like. More specific examples thereof include wall surfaces, ceilings, floors, underfloors, columns, fanlights, windows, doors, or cellulose ingredient-containing materials (wood products) of the above-mentioned place through which a sanitary insect pest can pass and place where a sanitary insect pest can inhabit.

The treatment of the place through which a sanitary insect pest can pass and the place where a sanitary insect pest can inhabit with the control agent according to the present embodiment is performed by the methods of spraying, application and transpiration, or combinations thereof.

Examples of the materials of the place through which a sanitary insect pest can pass and the place where a sanitary insect pest can inhabit include, but are not limited to, concrete (cement), brick, bamboo, wood, tile, ceramic, mud, metal, plastic, straw, galvanized iron and the like.

The surface of the place through which a sanitary insect pest can pass and the place where a sanitary insect pest can inhabit is treated with control agent, thus making it possible to support the active ingredient on the surface. The amount of the active ingredient to be supported may be appropriately adjusted according to application period, application site, treatment method and the like. For example, the amount of an active ingredient per 1 m² is usually 5 to 1,000 mg, preferably 5 to 500 mg, and more preferably 5 to 300 mg.

When the present control agent is used to control insect pests which reach buildings through the soil to damage the buildings, the present control agent can be applied to the underfloor soil of buildings. In this case, it is possible to use treatment methods such as a band application method, a planar spraying method, a soil surface film formation method, a foaming method and a soil surface sheet laying method.

The sanitary insect pest, which can be controlled by the control agent and the sanitary insect pest control method according to the present embodiment, include arthropods and mollusks which are harmful to humans and domestic animals, and arthropods and mollusks which are disliked because of their weird shapes or large outbreaks (also referred to as nuisance insect pests). Specific examples thereof include the following.

### Arthropod

### Blattodea:

Family: Ectobiidae such as German cockroach (Blattella germanica); Family: Blattidae such as smoky-brown cockroach (Periplaneta fuliginosa), American cockroach (Periplaneta Americana), Australian cockroach (Periplaneta australasiae), brown cockroach (Periplaneta brunnea), black cockroach (Blatta orientalis), Turkistan cockroach (Blatta lateralis) and Brown-banded cockroach (Supella longipalpa); and Family: Termitidae such as noodle worm (Reticulitermes speratus), Formosan subterranean termite (Coptotermes formosanus), Asian subterranean termite (Coptotermes gestroi), western drywood termite (Incisitermes minor), Daikoku drywood termite (Cryptotermes domesticus), Odontotermes formosanus, Neotermes koshunensis, Glyptotermes satsumensis, Glyptotermes nakajimai, Glyptotermes fuscus, Hodotermopsis sjostedti, Coptotermes guangzhouensis, Reticulitermes amamianus, Reticulitermes miyatakei, Reticulitermes kanmonensis, Nasutitermes takasagoensis, Pericapritermes nitobei, Sinocapritermes mushae, Cornitermes cumulans, Reticulitermes flavipes, Cryptotermes brevis, Cryptotermes havilandi, Macrotermes gilvus, Schedorhinotermes medioobscurus, Microcerotermes crassus, Nasutitermes javanicus, Coptotermes kalshoveni, Nasutitermes corniger, Heterotermes tenuis, Coptotermes curvignathus and Coptotermes acinaciformis.

### Siphonaptera:

Family: Pulicidae such as human flea (Pulex irritans), cat flea (Ctenocephalides felis), dog flea (Ctenocephalides canis), oriental rat flea (Xenopsylla cheopis) and chicken flea (Echidnophaga gallinacea); Family: Hectopsyllidae such as chigoe flea (Tunga penetrans); and Family: Ceratophyllidae such as European rat flea (Nosopsyllus fasciatus).

### Psocodae:

Family: Trogiidae such as book lice (Trogium pulsatorium); and Family: Liposcelidae or Liposcelididae such as book lice (Liposcelis corrodens), book lice (Liposcelis bostrychophila), Grocelis booklouse (Liposcelis pearmani) and dried fish booklouse (Liposcelis entomophila).

### Thysanura:

Family: Lepismatidae such as oriental silverfish (Ctenolepisma villosa) and moth fish (Lepisma saccharina).

### Acari:

Family: Ixodidae such as Haemaphysalis longicornis, Haemaphysalis flava, Haemaphysalis japonica, Haemaphysalis campanulata, American dog tick (Dermacentor variabilis), Dermacentor taiwanensis, Rocky Mountain wood tick (Dermacentor andersoni), ornate COW tick (Dermacentor reticulatus), Ixodes ovatus, taiga tick (Ixodes persulcatus), black-legged tick (Ixodes scapularis), western black-legged tick (Ixodes pacificus), Ixodes holocyclus, Ixodes ricinus, lone star tick (Amblyomma americanum), gulf coast tick (Amblyomma maculatum), pantropic cattle tick (Rhipicephalus microplus), cattle tick (Rhipicephalus annulatus), brown dog tick (Rhipicephalus sanguineus), Rhipicephalus appendiculatus and Rhipicephalus decoloratus; Family: Argasidae such as fowl tick (Argas persicus), Ornithodoros hermsi and Ornithodoros turicata; Family: Acaridae such as cereal mite (Tyrophagus putrescentiae) and grassland mite (Tyrophagus similis); Family: Pyroglyphidae such as American house dust mite (Dermatophagoides farinae) and European house dust mite (Dermatophagoides pteronyssinus); Family: Cheyletidae such as Cheyletus eruditus, Cheyletus malaccensis, Chelacaropsis moorei and Cheyletiella yasguri; Family: Psoroptidae such as sheep scab mite (Psoroptes ovis), horse psoroptic mange mite (Psoroptes equi), Knemidocoptes mutans, ear mange mite and genus Chorioptes spp.; (Otodectes cynotis) Family: Sarcoptidae such as Notoedres cati, Notoedres muris and itch mite (Sarcoptes scabiei); Family: Listrophoridae such as Listrophorus gibbus; Family: Dermanyssidae such as bird mite (Dermanyssus gallinae); Family: Macronyssidae such as feather mite (Ornithonyssus and sylviarum) tropical rat mite (Ornithonyssus bacoti); Family: Varroidae such as Varroa mite (Varroa jacobsoni); Family: Demodicidae such as dog follicle mite (Demodex canis) and cat follicle mite (Demodex cati); and Family: Trombiculidae such as Leptotrombidium akamushi, Leptotrombidium pallidum and Leptotrombidium scutellare.

### Hymenoptera:

Family: Formicidae, for example, Genus: Solenopsis spp. such as red imported fire ant (Solenopsis invicta), tropical fire ant (Solenopsis geminata), southern fire ant (Solenopsis xyloni) and black imported fire ant (Solenopsis richteri), Genus: Atta spp. such as brown leaf-cutting ant (Atta capiguara), Genus: Acromyrmex spp., Genus: Camponotus spp. such as bullet ant (Paraponera clavata), black house ant (Ochetellus glaber), little red ant (Monomorium pharaonis), Argentine ant (Linepithema humile), fire ant (Formica japonica), Japanese queenless ant (Pristomyrmex punctutus), African big-headed ant (Pheidole noda), big-headed ant (Pheidole megacephala), Japanese carpenter ant (Camponotus japonicus), Western honey bee (Camponotus obscuripes), black carpenter ant (Camponotus pennsylvanicus), Florida carpenter ant (Camponotus floridanus) and Western carpenter ant (Camponotus modoc), Genus: Pogonomyrmex spp. such as harvester ant (Pogonomyrmex sp.) and western harvester ant (Pogonomyrmex occidentalis), Genus: Wasmania spp. such as little fire ant (Wasmania auropunctata), Genus: Crematogaster spp., odorous house ant (Tapinoma sessile), pavement ant (Tetramorium caespitum), pyramid ant (Dorymyrmex insanus), European fire ant (Myrmica rubra) and long-legged ant (Anoplolepis gracilipes); Family: Vespidae such as Asian giant hornet (Vespa mandarinia), Japanese yellow hornet (Vespa simillima), yellow-vented hornet (Vespa analis), Asian yellow-legged hornet (Vespa velutina) and Dark-waist paper wasp (Polistes jokahamae); Family: Siricidae such as woodwasp (Urocerus gigas); and Family: Bethylidae.

### Coleoptera:

Family: Curculionidae such as maize wevil (Sitophilus zeamais), rice weevil (Sitophilus oryzae) and grain weevil (Sitophilus granarius); Family: Tenebrionidae such as red meal beetle (Tribolium castaneum), mason beetle (Tribolium confusum) and lesser mealworm (Alphitobius diaperinus); Family: Bostrychidae such as common powder-post beetle (Lyctus brunneus) and lesser grain borer (Rhizopertha dominica); Family: Ptinidae; Family: Cerambycidae such as citrus long-horned beetle (Anoplophora malasiaca), Migdolus fryanus and redneck longhorned beetle (Aromia bungii); Family: Elateridae such as sugarcane wireworm (Melanotus okinawensis), barley wireworm (Agriotes fuscicollis), click beetles (Melanotus legatus), genus Anchastus spp., genus Conoderus spp., genus Ctenicera spp., genus Limonius spp. and genus Aeolus spp.; Family: Staphylinidae such as rove beetle (Paederus fuscipes); Family: Dermestidae such as varied carpet beetle (Anthrenus verbasci), hide beetle (Dermestes maculates) and khapra beetle (Trogoderma granarium); Family: Anobiidae such as tobacco beetle (Lasioderma serricorne) and biscuit beetle (Stegobium paniceum); Family: Laemophloeidae such as flat grain beetle (Cryptolestes ferrugineus); Family: Silvanidae such as saw-toothed grain beetle (Oryzaephilus surinamensis); and Family: Nitidulidae such as blossom beetle (Brassicogethes aeneus).

### Diptera:

Family: Drosophilidae such as cherry drosophila (Drosophila suzukii) and common fruit fly (Drosophila melanogaster); Family: Phoridae such as Megaselia spiracularis; Family: Psychodidae such as bathroom fly (Clogmia albipunctata); Family: Sciaridae such as Bradysia difformis; Family: Culicidae such as southern house mosquito (Culex pipiens pallens), house mosquito (Culex tritaeniorhynchus), autogenic house mosquito (Culex pipiens f. molestus), brown house mosquito (Culex quinquefasciatus), northern house mosquito (Culex pipiens pipiens), Culex vishnui, Asian tiger mosquito (Aedes albopictus), dengue mosquito (Aedes aegypti), Chinese malaria mosquito (Anopheles sinensis), African malaria mosquito (Anopheles gambiae), Anopheles stephensi, Western malaria mosquito (Anopheles freeborni), woodland malaria mosquito (Anopheles punctipennis), common malaria mosquito (Anopheles quadrimaculatus), Anopheles coluzzii, Anopheles albimanus, Anopheles sundaicus, Anopheles arabiensis, Anopheles funestus, Anopheles darlingi, Anopheles farauti and Anopheles minimus; Family: Simulidae such as Prosimulium yezoensis, Simulium ornatum and black fly (Simulium spp.); Family: Tabanidae such as Gadfly (Tabanus trigonus), black house fly (Tabanus atratus), stripe black house fly (Tabanus lineola) and deer fly (Chrysops sp.); Family: Muscidae such as house fly (Musca domestica), false stable fly (Muscina stabulans), biting house fly (Stomoxys calcitrans) and buffalo fly (Haematobia irritans); Family: Calliphoridae such as Lucilia sp., Calliphora sp.; Family: Sarcophagidae such as flesh fly (Sarcophaga sp., Wohlfahrtia sp.); Family: Ceratopogonidae such as black gnat (Leptoconops sp.); Family: Chironomidae such as non-biting midges (Chironomus plumosus), Chironomus yoshimatsui and Glyptotendipes tokunagai; and Family: Fannidae.

### Lepidoptera:

Family: Tineidae such as casemaking clothes moth (Tinea translucens) and common clothes moth (Tineola bisselliella).

### Hemiptera:

Family: Cimicidae such as common bed bug (Cimex lectularius), and tropical bed bug (Cimex hemipterus); and Family: Cicadidae such as Quesada gigas; and Family: Reduviidae such as Triatoma infestans, Triatoma rubrofasciata, Triatoma dimidiata, Triatoma sanguisuga, Triatoma protracta, and Rhodonius prolixus.

### Araneae:

Family: Eutichuridae such as Cheiracanthium japonicum; Family: Theridiidae such as red-back spider (Latrodectus hasseltii).

### Polydesmida:

Family: Paradoxosomatidae such as flat-backed millipede (Oxidus gracilis) and Nedyopus tambanus.

### Isopoda:

Family: Armadillidiidae such as common pill bug (Armadillidium vulgare).

### Chilopoda:

Family: Scutigeridae such as Thereuonema hilgendorfi; Family: Scolopendridae such as giant tropical centipede (Scolopendra subspinipes); and Family: Ethopolyidae such as Bothropolys rugosus.

### Mollusks

### Gastropoda:

Family: Limacidae such as tree slug (Limax marginatus) and garden tawny slug (Limax flavus); Family: Philomycidae such as Japanese native slug (Meghimatium bilineatum); Family: Ampullariidae such as golden apple snail (Pomacea canaliculata); and Family: Lymnaeidae such as pond snail (Austropeplea ollula).

### EXAMPLES

The present invention will be described in more detail by way of Examples such as Formulation Examples and Test Examples, but the present invention should not be construed to be limited thereto.

First, Formulation Examples will be mentioned. Parts are by weight.

### Formulation Example 1

35 parts of a mixture (weight ratio of 1:1) of polyoxyethylene alkyl ether sulfate ammonium salt and silica, 10 parts of SX and 55 parts of water are mixed, followed by finely grinding by a wet grinding method to obtain a formulation.

### Formulation Example 2

50 Parts of SX, 3 parts of calcium lignin sulfonate, 2 parts of sodium lauryl sulfate and 45 parts of silica are ground and mixed to obtain a formulation.

### Formulation Example 3

5 Parts of SX, 9 parts of polyoxyethylene styryl phenyl ether, 5 parts of polyoxyethylene decyl ether (average number of ethylene oxide added: 5), 6 parts of calcium dodecylbenzene sulfonate and 75 parts of xylene are mixed to obtain a formulation.

### Formulation Example 4

2 Parts of SX, 1 part of silica, 2 parts of calcium lignin sulfonate, 30 parts of bentonite and 65 parts of kaolin clay are ground and mixed, and then an adequate amount of water is added, and after kneading the mixture, the kneaded mixture is granulated by a granulator and then dried to obtain a formulation.

### Formulation Example 5

10 Parts of SX is mixed with a mixture of 18 parts of benzyl alcohol and 9 parts of DMSO, and then 6.3 parts of GERONOL (registered trademark) TE250, of Ethylan NS-500LQ (registered trademark) and 54 parts of solvent naphtha are added, followed by mixing to obtain a formulation.

### Formulation Example 6

10 Parts of SX, 5 parts of nonylphenol ethoxylate and 85 parts of propylene glycol are mixed to obtain a formulation.

### Formulation Example 7

10 Parts of SX and 20 parts of xylene are mixed, and then the mixture is dispersed in 68 parts of water containing 2 parts of polyvinyl alcohol to obtain a formulation.

### Formulation Example 8

30 parts of SX, 3 parts of calcium lignin sulfonate, 2 parts of sodium lauryl sulfate and 65 parts of kaolin clay are ground and mixed, and then an adequate amount of water is added, and after kneading the mixture, the kneaded mixture is granulated by a granulator and then dried to obtain a formulation.

### Formulation Example 9

35 Parts of a mixture (weight ratio of 1:1) of polyoxyethylene alkyl ether sulfate ammonium salt and white carbon, 10 parts of SX and 55 parts of water are mixed and then finely ground by a wet grinding method, and the mixture thus obtained is granulated using a fluidized bed granulator to obtain a formulation.

### Formulation Example 10

20 Parts of SX, 5 parts of polyoxyethylene nonylphenyl ether, 3 parts of carboxylmethyl cellulose and 72 parts of water are mixed to obtain a formulation.

### Formulation Example 11

10 Parts of SX, 0.2 part of hexamethylene diisocyanate and 10 parts of xylene are mixed, and then dispersed in 75.8 parts of water containing 2 parts of polyvinyl alcohol. 2 Parts of ethylenediamine is added and an encapsulation reaction is allowed to proceed while mixing to obtain a formulation.

### Formulation Example 12

2 Parts of SX, 88 parts of kaolin clay and 10 parts of talc are ground and mixed to obtain a formulation.

### Formulation Example 13

60 parts of SX, 10 parts of special sodium aromatic sulfonate formalin condensate (trade name: DEMOL SN-B, manufactured by Kao Corporation), 4 parts of sodium lauryl sulfate (trade name: EMAL 10 Powder, manufactured by Kao Corporation) and 26 parts of kaolin-based clay (trade name: A clay, manufactured by Shokozan Mining Co., Ltd.) are mixed and then ground by an air mill.

Next, 11 parts of water is added to the grind, and after well kneading, the kneaded mixture thus obtained is granulated by a portable extrusion granulator equipped with a 0.7 mmo screen, dried at 60° C. for 10 minutes and then sized to obtain a granular wettable powder.

### Formulation Example 14

50 Parts of SX, 3.0 parts of sodium diisopropyl naphthalene sulfonate, 4.0 parts of sulfomethylated sodium lignosulfonate, 0.25 part of cellulose carboxymethyl ether sodium salt, 1.0 parts of amorphous silica and 41.75 parts of lactose are mixed and then ground by an air mill.

Next, 10 parts of water is added to the grind, and after kneading, the kneaded mixture thus obtained is granulated by a portable extrusion granulator equipped with a 1.0 mmo screen, dried at 60° C. for 10 minutes and then sized to obtain a granular wettable powder.

### Formulation Example 15

43.4 Parts of SX, 0.2 part of a silicone-based defoamer (trade name: Xiameter ACP-1500 Antifoam compound, manufactured by Dow Corning Toray Co., Ltd.), 3.4 parts of polyoxyethylene tristyryl phenyl ether phosphoric acid triethanolamine salt (trade name: Soprophor FL, manufactured by Solvay S.A.), 4.3 parts of propylene glycol and 20.5 parts of deionized water are mixed and then wet ground by a bead mill to obtain a suspension.

Separately, 0.3 part of aluminum magnesium silicate (trade name: VEEGUM R, manufactured by Vanderbilt Minerals, LLC), 0.2 part of xanthan gum (trade name: Kelzan, manufactured by CP Kelco) and 0.2 part of a preservative (containing 1,2-benzoisothiazolin-3-one as an active ingredient, trade name: Proxel GXL, manufactured by Lonza) are mixed and then dissolved and dispersed in 27.5 parts by weight of deionized water to prepare a thickening agent solution, which is mixed with the above suspension to obtain an aqueous suspension composition.

### Formulation Example 16

40 Parts of SX, 5 parts of sodium lignin sulfonate (trade name: Reax 85A, manufactured by Ingevity, weight-average molecular weight of 10,000, sulfonation degree of 0.8), 0.5 part of a silicone-based defoamer (trade name: Xiameter ACP-1500 Antifoam compound, manufactured by Dow Corning Toray Co., Ltd.), 5 parts of propylene glycol, 1 part of silica (trade name: Aerosil COK-84, manufactured by Evonik) and 48.3 parts of deionized water are mixed, and then wet ground using a horizontal bead mill (trade name: DYNO-MILL KDL, manufactured by WILLY A. BACHOFEN AG Maschinenfabrik) to obtain a suspension.

To the suspension thus obtained, 0.2 part of a preservative (containing 1,2-benzoisothiazolin-3-one as an active ingredient, trade name: Proxel GXL, manufactured by Lonza Lonza) is added, followed by mixing to obtain an aqueous suspension composition of the present invention.

Next, Test Examples indicate the control effect of the present invention.

The following specifically indicate that the present compound has the sanitary insect pest control effect. The present compound A, the present compound B, and comparative compounds 1 to 4 are compounds listed in Table 2. Comparative compounds 1 and 2 are compounds mentioned in Patent Document 4, and comparative compounds 3 and 4 are compounds mentioned in Patent Document 3.

TABLE 2

| | |
|---|---|
| Present compound A | 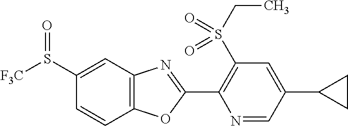 |
| Present compound B | 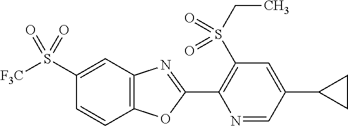 |
| Comparative compound 1 | 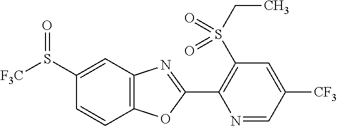 |
| Comparative compound 2 | 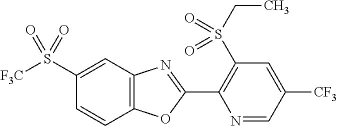 |
| Comparative compound 3 | 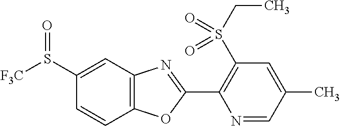 |
| Comparative compound 4 | 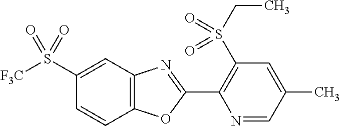 |

Excellent sanitary insect pest control effect of the present compound can be confirmed, for example, by the following Test Examples.

### Test Example 1

In a 20 mL volume vial, 0.2 mL of an acetone solution (containing 0.09% of a surfactant added therein) which contains prescribed amount of the present compound A, the present compound B, comparative compound 1, comparative compound 2, comparative compound 3, or comparative compound 4 was added dropwise and the inner wall of the vial was coated homogeneously with the chemicals and then air-dried. Thereafter, five German cockroaches (Blattella germanica) were released and the vial was sealed with a lid. After 6 hours, the number of dead and moribund individuals of German cockroaches was examined, and moribund and mortal rates (%) were determined by the equation 1 below. Dead individuals are completely immobile individuals, and moribund individuals are individuals who cannot get up when turned on their backs, and are non-ambulatory.

The moribund and mortal rates (%) obtained by the test are shown in Table 3.

Moribund and mortal rates (%)={(number of dead individuals+number of moribund individuals)/number of tested individuals}×100 (Equation 1)

The amount to be treated per area was set at 1000, 300, 150, 50 and 5 mg/m².

TABLE 3

| | Amount to be treated per area (mg/m²) - Moribund and | | | | |
|---|---|---|---|---|---|
| | mortal rates (%) after 1 day | | | | |
| Compound | 1,000 | 300 | 150 | 50 | 5 |
| Present | 100 | 100 | 100 | 100 | 100 |
| compound A | | | | | |
| Present | 100 | 100 | 100 | 100 | 100 |
| compound B | | | | | |
| Comparative | 100 | 50 | 50 | 30 | 10 |
| compound 1 | | | | | |
| Comparative | 100 | 50 | 20 | 10 | 10 |
| compound 2 | | | | | |
| Comparative | 100 | 40 | 30 | 30 | 10 |
| compound 3 | | | | | |
| Comparative | 100 | 30 | 20 | 10 | 10 |
| compound 4 | | | | | |

### Test Example 2

In a 250 mL volume vial, 1.0 mL of an acetone solution (containing 0.09% of a surfactant added therein) which contains prescribed amount of the present compound A, the present compound B, comparative compound 1, comparative compound 2, comparative compound 3, or comparative compound 4 was added dropwise and the inner wall of the vial was coated homogeneously with the chemicals and then air-dried. Thereafter, female adult African malaria mosquitos (Anopheles gambiae) were released and the vial was sealed with a lid, followed by exposure for 50 minutes. 50 Minutes after exposure, African malaria mosquitos were transferred to a new plastic cup, followed by feeding sugar water. After 4 days, the number of dead and moribund individuals of African malaria mosquitos was examined, and moribund and mortal rates (%) were determined by the equation 2 below. Dead individuals are completely immobile individuals, and moribund individuals are individuals who are flightless and non-ambulatory.

The moribund and mortal rates (%) obtained by the test are shown in Table 4.

Moribund and mortal rates (%)={(number of dead individuals+number of moribund individuals)/number of tested individuals}×100 (Equation 2)

The amount to be treated per area was set at 300, 10 and 5 mg/m².

TABLE 4

| | Amount to be treated per area (mg/m²) - Moribund and | | |
|---|---|---|---|
| | mortal rates (%) after 4 days | | |
| Compound | 300 | 10 | 5 |
| Present | 100 | 100 | 100 |
| compound A | | | |
| Present | 100 | 100 | 100 |
| compound B | | | |
| Comparative | 53 | 43 | 3 |
| compound 1 | | | |
| Comparative | 15 | 13 | 8 |
| compound 2 | | | |
| Comparative | 35 | 7 | 6 |
| compound 3 | | | |
| Comparative | 26 | 15 | 8 |
| compound 4 | | | |

### Test Example 3

In a 20 mL volume vial, 0.2 mL of an acetone solution (containing 0.09% of a surfactant added therein) which contains prescribed amount of the present compound A, the present compound B, comparative compound 1, comparative compound 2, comparative compound 3, or comparative compound 4 was added dropwise and the inner wall of the vial was coated homogeneously with the chemicals and then air-dried. Thereafter, little red worker ants (Monomorium pharaonis) were released and the vial was sealed with a lid. After 1 hour, little red worker ants in the vial were transferred to a new plastic cup, followed by feeding 38 sucrose water. After 1 day, the number of dead and moribund individuals was examined, and moribund and mortal rates (%) were determined by the equation 3 below. Dead individuals are completely immobile individuals, and moribund individuals are individuals who cannot get up when turned on their backs, and are non-ambulatory.

The moribund and mortal rates (%) obtained by the test are shown in Table 5.

Moribund and mortal rates (%)={(number of dead individuals+number of moribund individuals)/number of tested individuals}×100 (Equation 3)

The amount to be treated per area was set at 300, 100 and 5 mg/m².

TABLE 5

| | Amount to be treated per area (mg/m²) - Moribund and | | |
|---|---|---|---|
| | mortal rates (%) after 1 day | | |
| Compound | 300 | 100 | 5 |
| Present | 100 | 100 | 100 |
| compound A | | | |
| Present | 100 | 100 | 100 |
| compound B | | | |
| Comparative | 100 | 40 | 30 |
| compound 1 | | | |
| Comparative | 100 | 50 | 20 |
| compound 2 | | | |
| Comparative | 100 | 30 | 10 |
| compound 3 | | | |
| Comparative | 100 | 20 | 10 |
| compound 4 | | | |

### Test Example 4

0.6 mL of an acetone solution containing prescribed amount of the present compound A, the present compound B, comparative compound 1, comparative compound 2, comparative compound 3, or comparative compound 4 was added dropwise on a filter paper having a diameter of 82 mm, followed by air drying. The filter paper was attached to a plastic petri dish having a diameter of 90 mm without gaps by adding dropwise 1.4 mL of water, and then Formosan subterranean worker termites (Coptotermes formosanus) were released and the vial was sealed with a lid, followed by exposure for 1 hours. After exposure for 1 hour, Formosan subterranean worker termites were transferred to a new plastic cup with bottom lined with the filter paper, followed by feeding water. After 3 days, the number of dead and moribund individuals of Formosan subterranean worker termites was examined, and moribund and mortal rates (%) were determined by the equation 4 below. Dead individuals are completely immobile individuals, and moribund individuals are individuals who are flightless and non-ambulatory.

The moribund and mortal rates (%) obtained by the test are shown in Table 6.

Moribund and mortal rates (%)={(number of dead individuals+number of moribund individuals)/number of tested individuals}×100 (Equation 4)

The amount to be treated per area was set at 1,000, 500 and 300 mg/m².

TABLE 6

| | Amount to be treated per area (mg/m²) - Moribund and | | |
|---|---|---|---|
| | mortal rates (%) after 3 days | | |
| Compound | 1,000 | 500 | 300 |
| Present | 100 | 100 | 100 |
| compound A | | | |
| Present | 100 | 100 | 100 |
| compound B | | | |
| Comparative | 100 | 30 | 10 |
| compound 1 | | | |
| Comparative | 100 | 20 | 10 |
| compound 2 | | | |
| Comparative | 100 | 10 | 10 |
| compound 3 | | | |
| Comparative | 100 | 10 | 10 |
| compound 4 | | | |

The results revealed that the present compounds A and B have excellent control effect against sanitary insect pests as compared with Comparative Compounds 1 to 4.

### INDUSTRIAL APPLICABILITY

The control method of the present invention can easily control sanitary insect pests.

1. A sanitary insect pest control method, which comprises applying a sanitary insect pest control agent comprising at least one compound selected from the group consisting of a compound represented by formula (I): 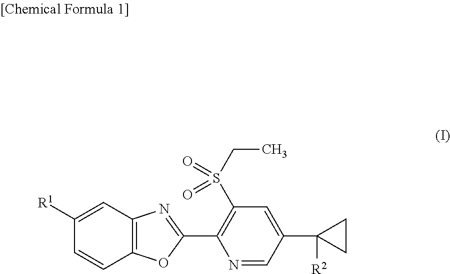
wherein
R¹ represents a C1-C3 haloalkoxy group, a C1-C3 haloalkylthio group, a C1-C3 haloalkylsulfinyl group or a C1-C3 haloalkylsulfonyl group, and
R² represents a hydrogen atom or a cyano group, an N-oxide thereof and a salt thereof to a place through which a sanitary insect pest can pass, a place where the sanitary insect pest can inhabit, or both the places so that an amount of an active ingredient per 1 m² becomes 5 to 1,000 mg.

2. The sanitary insect pest control method according to claim 1, wherein the amount of the active ingredient per 1 m² is 5 to 300 mg.

3. The sanitary insect pest control method according to claim 1, wherein R¹ is a trifluoromethylsulfinyl group or a trifluoromethylsulfonyl group, and R² is a hydrogen atom in formula (I).

4. The sanitary insect pest control method according to claim 1, wherein the place through which the sanitary insect pest can pass or the place where the sanitary insect pest can inhabit, or both the places is/are composed of a surface constituting an indoor or outdoor structure, or a surface around the structure.

5. The sanitary insect pest control method according to claim 4, wherein a treatment with the sanitary insect pest control agent includes supporting the compound of formula (I) on any one of the surfaces.

6. The sanitary insect pest control method according to claim 1, wherein the sanitary insect pest control agent is a sanitary insect pest control agent which further contains at least one active ingredient.

7. The sanitary insect pest control method according to claim 6, wherein the active ingredient is at least one selected from the group consisting of cypermethrin, alpha-cypermethrin, bifenthrin, cyfluthrin, beta-cyfluthrin, lambda-cyhalothrin, deltamethrin, esfenvalerate, etofenprox, prallethrin, permethrin, pyrethrins, chlorfenapyr, abamectin, acetamiprid, clothianidin, dinotefuran, resmethrin, imidacloprid, thiamethoxam, thiacloprid, indoxacarb, broflanilide, fenitrothion, cyphenothrin, pyriproxyfen, fipronil, phenothrin, sulfoxaflor, broflanilide, pirimiphos-methyl, bendiocarb, piperonyl butoxide and N-(2-ethylhexyl)-8,9,10-trinorborn-5-ene-2,3-dicarboxyimide.

8. The sanitary insect pest control method according to claim 1, wherein the sanitary insect pest is at least one sanitary insect pest selected from the group consisting of sanitary insect pests of the orders Blattodea, Hymenoptera, Diptera, Siphonaptera, Acari, Lepidoptera and Coleoptera.

9. The sanitary insect pest control method according to claim 1, which includes spraying the sanitary insect pest control agent after being diluted with water.

10. The sanitary insect pest control method according to claim 1, wherein the sanitary insect pest control agent is an oil, an emulsifiable concentrate, a wettable powder, a water dispersible granule, a flowable or a microcapsule.

11. The sanitary insect pest control method according to claim 2, wherein R¹ is a trifluoromethylsulfinyl group or a trifluoromethylsulfonyl group, and R² is a hydrogen atom in formula (I).

12. The sanitary insect pest control method according to claim 2, wherein the sanitary insect pest control agent is a sanitary insect pest control agent which further contains at least one active ingredient.

13. The sanitary insect pest control method according to claim 2, wherein the sanitary insect pest is at least one sanitary insect pest selected from the group consisting of sanitary insect pests of the orders Blattodea, Hymenoptera, Diptera, Siphonaptera, Acari, Lepidoptera and Coleoptera.

14. The sanitary insect pest control method according to claim 2, which includes spraying the sanitary insect pest control agent after being diluted with water.

15. The sanitary insect pest control method according to claim 2, wherein the sanitary insect pest control agent is an oil, an emulsifiable concentrate, a wettable powder, a water dispersible granule, a flowable or a microcapsule.

16. The sanitary insect pest control method according to claim 3, wherein the sanitary insect pest control agent is a sanitary insect pest control agent which further contains at least one active ingredient.

17. The sanitary insect pest control method according to claim 3, wherein the sanitary insect pest is at least one sanitary insect pest selected from the group consisting of sanitary insect pests of the orders Blattodea, Hymenoptera, Diptera, Siphonaptera, Acari, Lepidoptera and Coleoptera.

18. The sanitary insect pest control method according to claim 3, which includes spraying the sanitary pest control agent after being diluted with water.

19. The sanitary insect pest control method according to claim 3, wherein the sanitary insect pest control agent is an oil, an emulsifiable concentrate, a wettable powder, a water dispersible granule, a flowable or a microcapsule.
